(19) United States
(12) Patent Application Publication
(10) Pub. No.: US 2006/0108199 A1
(43) Pub. Date: May 25, 2006

(54) Device for feeding ordered groups of cigarettes

(76) Inventor: Mario Spatafora, Granarolo (IT)

Correspondence Address: Harbin King & Klima, 500 Ninth Street SE, Washington, DC, 20003, US

(21) Appl. No.: 11/282,819

(22) Filed: Nov. 21, 2005

(30) Foreign Application Priority Data
Nov. 19, 2004 (IT) BO2004A 000719

(51) Int. Cl. B65G 47/26

(52) U.S. Cl. 198/453; 198/418

(57) ABSTRACT

Cigarettes entering a packer are directed en masse into a device comprising a hopper with a number of distinct feed sections, each having a dedicated inlet and outlet and enclosed on one side by an access door, from which the single cigarettes are transferred to respective assembly stations and thereupon formed into ordered groups. Located alongside each inlet is a suction field provided by an array of holes allowing a fluid connection between the hopper and a vacuum duct; a chamber forming part of the vacuum duct houses a valve element able to alternate between an extended active position in which the holes are shut off, and a retracted inactive position in which the holes are able to attract and immobilize the cigarettes, thereby allowing inspection of the feed section by an operator; movement of the valve element is interlocked to the access door.

### BACKGROUND OF THE INVENTION

The present invention relates to a device for feeding ordered groups of cigarettes in a packaging machine.

The device according to the present invention is described in the following specification, albeit with no limitation in scope implied, as applicable to a cigarette packer in which its function is to feed cigarettes and form them into a succession of ordered groups, each providing the contents of one packet of cigarettes.

The feed device disclosed comprises a hopper, embodied typically as a flow chamber designed to accommodate cigarettes en masse and associated with a plurality of feed sections.

Each feed section is furnished with an inlet and a plurality of feed channels, delimited by pairs of baffles, along which the cigarettes advance toward an outlet positioned alongside an assembly station where the single cigarettes are formed into ordered groups.

The assembly station generally comprises a pusher mechanism by which the ordered groups of cigarettes are transferred into respective conveying elements; the groups are then carried on these same elements toward further processing stations.

It has been found in certain cases, during the operation of the packer, that cigarettes advancing along the feed channels can become positioned incorrectly and thus impede the smooth progress of the other cigarettes.

As a direct consequence of this drawback, groups formed from cigarettes transferred to the assembly station may emerge incomplete, and will have to be rejected during the course of subsequent burdensome checking operations.

Self-evidently, therefore, any impediment to the smooth progress of the cigarettes must be removed as swiftly as possible.

Ideally, moreover, at the moment when action is taken by the operator to remove the aforementioned impediment, it should be possible to immobilize the advancing cigarettes internally of the affected feed section.

Cigarette packers of prior art design are not devoid of drawbacks in this regard.

With machines of conventional design, in effect, cigarettes advancing internally of the single feed sections cannot be brought to a halt effectively and promptly.

The object of the present invention is to provide a device for feeding ordered groups of cigarettes that will be unaffected by the drawbacks mentioned above in connection with the prior art.

### SUMMARY OF THE INVENTION

The stated object is realized according to the invention in a device for feeding ordered groups of cigarettes in a packaging machine, comprising: a hopper incorporating a plurality of feed sections from which cigarettes are directed into respective assembly stations to be formed into ordered groups, each feed section comprising an inlet and an outlet through which the cigarettes are directed, and a plurality of feed channels located between the inlet and the outlet and delimited by pairs of dividing baffles; pusher mechanisms associated one with each assembly station and serving to transfer each of the ordered groups to respective conveying means by which the groups are then directed toward further processing stations, each pusher mechanism singly deselectable in the event of defects being detected in the formation of the groups of cigarettes; means affording access to the feed sections for inspection and maintenance purposes; and means, interlocked to the pusher mechanism or to the access means, by which to block the movement of the cigarettes along the channels toward the assembly station.

### BRIEF DESCRIPTION OF THE DRAWINGS

The invention will now be described in detail, by way of example, with the aid of the accompanying drawings, in which:

FIG. 1 shows a portion of a cigarette packing machine, viewed schematically in a side elevation with certain parts cut away for clarity, and equipped with a device according to the invention illustrated in a preferred embodiment;

FIG. 2 is a schematic plan view illustrating a portion of the machine in FIG. 1, shown with certain parts omitted for clarity and others in section;

FIG. 3 shows a detail of the feed device in FIG. 1, viewed schematically in a front elevation with certain parts cut away for clarity;

FIG. 4 shows the device of FIG. 1, viewed schematically in a side elevation with certain parts in section and others cut away for clarity;

FIG. 5 shows a second embodiment of the feed device according to the present invention, viewed schematically in a front elevation with certain parts cut away for clarity.

### DESCRIPTION OF THE PREFERRED EMBODIMENTS

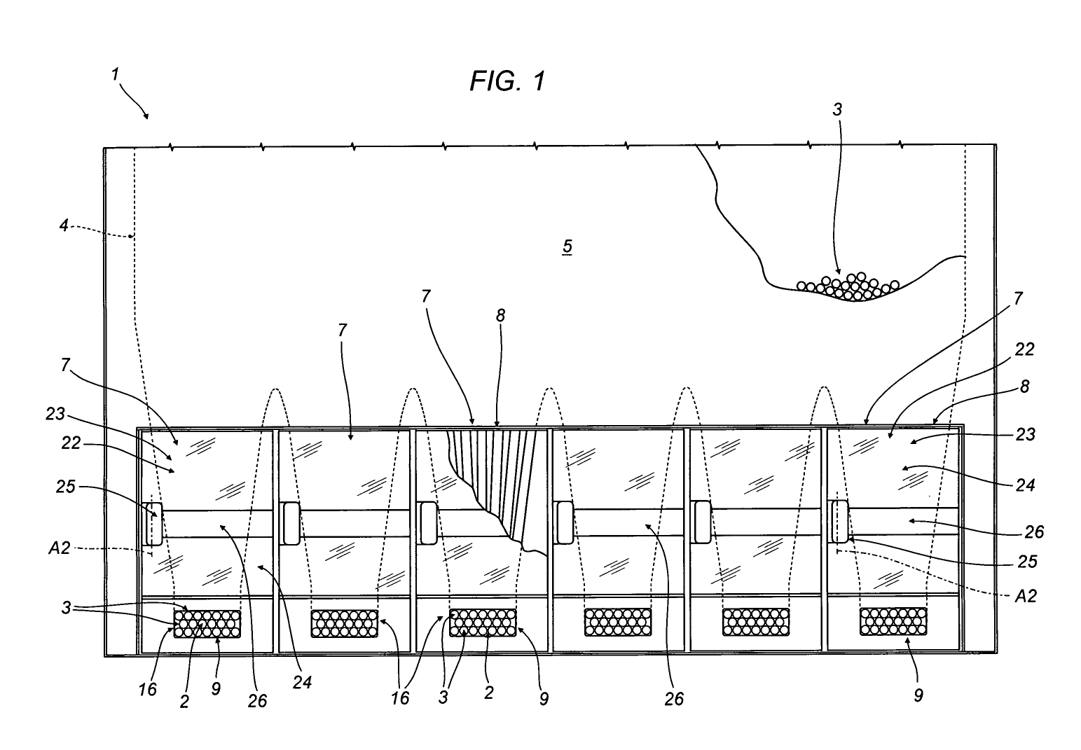

With reference to FIG. 1, numeral 1 indicates a feed device, in its entirety, integrated into a cigarette maker-packer line. The device 1 serves to form single cigarettes 3 into ordered groups 2, each ultimately providing the contents of a single packet (not illustrated).

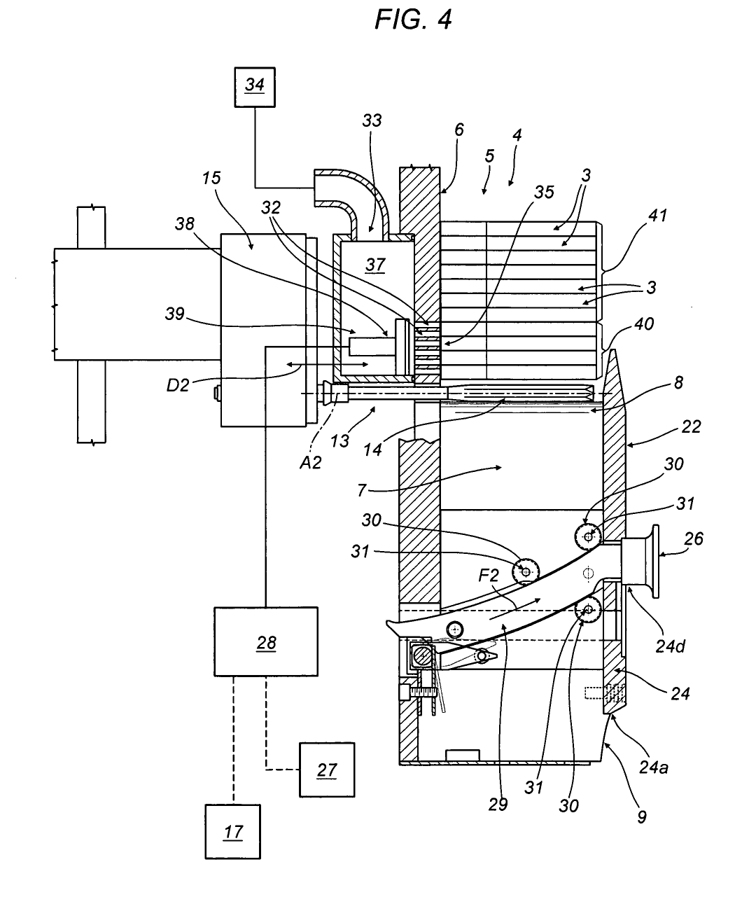

The device 1 comprises a hopper 4, which in turn incorporates a flow chamber 5 of substantially familiar type, delimited at the front and rear by two flat walls parallel to the viewing plane of FIG. 1, of which one only, a rear wall denoted 6, is indicated in FIG. 4; the hopper 4 is designed to accommodate cigarettes 3 en masse, positioned substantially horizontal and perpendicular to the front and rear walls of the flow chamber 5.

Still referring to FIG. 1, the hopper 4 further comprises a plurality of feed sections 7, each of which presenting an inlet 8 and an outlet 9.

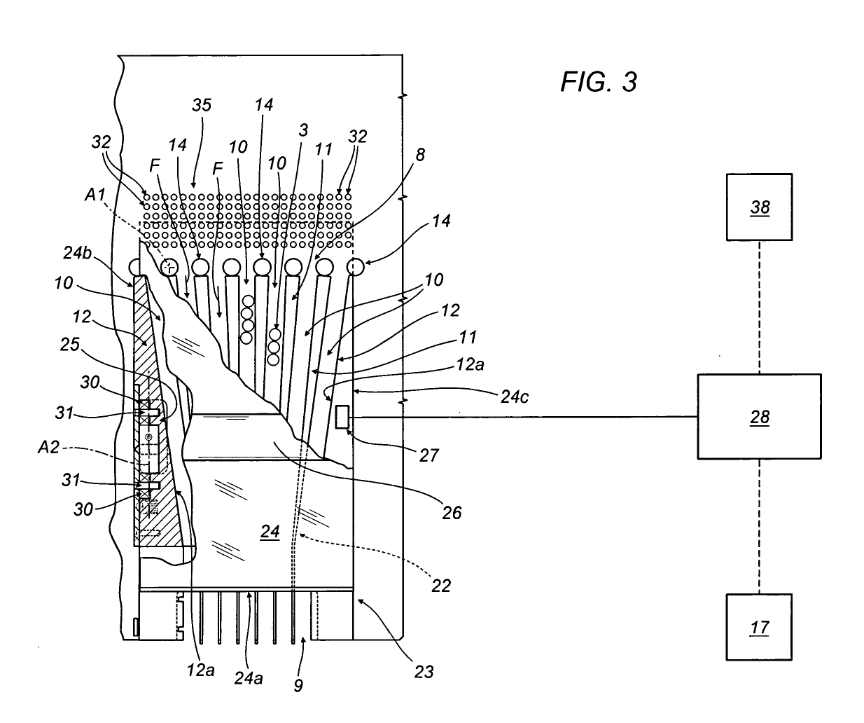

As illustrated in FIG. 3, each feed section 7 comprises a plurality of feed channels 10 arranged side by side and converging toward the outlet 9, which are delimited laterally by pairs of dividing baffles 11, likewise mutually convergent.

Each channel 10 is designed to allow the descent of a relative column of cigarettes 3 along a feed direction denoted F.

The feed section 7 as a whole is also delimited laterally by respective side walls 12 of which the relative inside faces 12a are inclined convergently toward the outlet 9.

To ease the passage of the cigarettes 3 through the flow chamber 5 and toward the channels 10, as illustrated in FIGS. 3 and 4, the feed device 1 comprises an agitator device located internally of the chamber 5 and denoted 13 in its entirety. The device 13 in question incorporates a plurality of agitator elements 14, substantially polygonal in section, activated by drive means 15 in familiar fashion (not illustrated) and in such a way as to rock on relative axes A1 extending substantially horizontal and perpendicular to the aforementioned walls of the hopper.

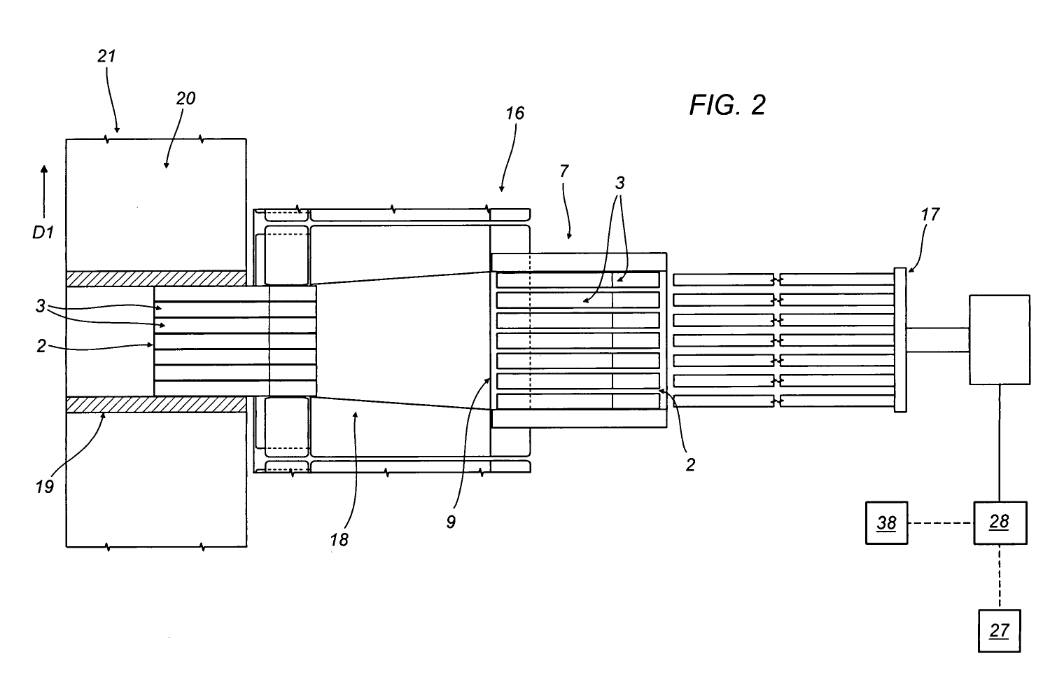

As illustrated in FIG. 2, and in accordance with the prior art, the device 1 further comprises a plurality of assembly stations 16, each located near the outlet 9 of a respective feed section 7, in which the aforementioned groups 2 of cigarettes are formed.

Each assembly station 16 comprises a pusher mechanism 17 positioned on one side of the outlet 9 and a guide 18 placed on the side opposite.

The function of the pusher mechanism 17 is to transfer the ordered groups 2 of cigarettes 3 into respective pockets 19 of a conveyor 20 (familiar in embodiment and not described further) advancing along a feed direction denoted D1.

The pocket conveyor 20 constitutes feed means 21 by which the groups 2 of cigarettes 3 are directed toward further processing stations not illustrated in the drawings.

Referring to FIGS. 1 and 3, each feed section 7 comprises a removable front wall 22 that provides the device 1 with means 23 affording access to the selfsame section 7, such as will enable an operator to make an inspection and allow the removal of any obstacle to the smooth passage of the cigarettes 3 along the channels 10.

In particular, the removable wall 22 consists in a door 24 capable of movement between a first or closed configuration indicated in FIGS. 1 and 3, and a second or open configuration, not indicated, in which the inside of the feed section 7 is made accessible.

The door 24 presents a bottom edge 24a coinciding with the top of the outlet 9, a first side edge 24b connected by way of a hinge 25 to one of the side walls 12 of the feed section 7, and a second side edge 24c opposite to the first side edge 24b.

The hinge 25 is substantially conventional in embodiment and illustrated in outline only.

With reference to FIGS. 1 and 4, numeral 26 denotes a handle 26 fastened to an outer face 24d of the door 24. Using the handle 26, the door 24 can be swung on an axis A2 of the hinge 25 between a closed position, illustrated in FIG. 3, and an open position (not illustrated in the drawings) in which the relative feed channel 10 is accessible from the outside for maintenance purposes.

Mounted to one of the side walls 12 of the feed section 7 is a sensor, denoted 27, connected to a computerized control unit illustrated schematically in FIG. 3 as a block 28.

The operation of the sensor 27 and of the control unit 28 will be described more fully in due course.

As illustrated in FIGS. 3 and 4, the hinge 25 of the door 24 is mounted to a glide element 29 coupled slidably with three small guide rollers 30 carried by one of the side walls 12 and rotatable freely on respective pivots 31.

Accordingly, the opening movement of the door 24 is generated by a combination of movements, with the door 24 itself swinging on the axis A2 of the hinge 25, and the hinge 25 sliding together with the glide element 29 in the direction of the arrow denoted F2.

In effect, the compound movement described above is intended to ensure that when the door 24 assumes the open position, it will not encroach on a given area in front of the outlet 9 presented by the feed section 7 of the hopper 4, which must remain free in order to allow the passage of the aforementioned pockets 19 of the conveyor 20.

Still observing FIGS. 3 and 4, the rear wall 6 of the hopper 6 presents a plurality of through holes 32 located near to the inlet 8 of each feed section 7, arranged in a rank and file formation that occupies substantially the full width of the section 7 between the two side walls 12.

The holes 32 serve to create a fluid connection between the hopper 4 and a vacuum duct denoted 33, which is connected in turn to a conventional source of negative pressure illustrated schematically in FIG. 4 as a block 34.

More exactly, the holes 32 combine to create a suction field 35 by means of which a plurality of cigarettes 3 can be held in contact with the flat rear wall 6 of the hopper 4.

The suction field 35, its constituent holes 32 and the vacuum duct 33 together establish means 36 of pneumatic type by which to block the movement of the cigarettes 3 along the feed channels 10.

With reference to FIG. 4, the vacuum duct 33 comprises a chamber 37 in communication with the holes 32 and accommodating a valve element 38 such as will cut off the fluid connection between the hopper 4 and the vacuum duct 33.

To this end, the valve element 38 is capable of movement, in a direction denoted D2, between a first active position, extended and disallowing aspiration through the holes 32, and a second inactive position, retracted as shown in FIG. 4 and allowing aspiration; the movement of the valve element 38 between the first and second positions is induced, through the agency of relative actuator means (not indicated), in response to a signal indicating the status of the pusher mechanism 17 and/or the door 24 aforementioned.

The valve element 38 furnishes the device 1 with means 39 by which to shut off the suction field 35. In normal operation, as evident from FIG. 1, cigarettes 3 occupying the flow chamber 5 of the hopper 4 will gravitate toward each of the feed sections 7 presented by the selfsame hopper 4.

With reference to FIGS. 3 and 4, the movement of the cigarettes 3 is assisted by the agitator elements 14, which are able to prevent the flow from clogging upstream of the inlet 8 at each of the feed sections 7; in effect, any such congestion could create a void in the flow of cigarettes 3 and break its continuity.

Thus, the subsequent passage of the cigarettes 3 into and along the single channels 10 will also be assisted by a relative agitator element 14 located internally of the flow chamber 5, near the top end of the channel 10.

The agitator elements 14 are coupled in familiar fashion to the aforementioned drive means 15 and caused to rock on their axes A1, alternating at a predetermined frequency and amplitude.

It can happen on occasion, having passed into the feed channels 10, that certain of the cigarettes 3 become positioned incorrectly within the selfsame channels 10; in this situation, the flow of single cigarettes 3 along a given channel 10 may be halted completely.

In order to exclude any possibility that groups 2 of cigarettes 3 could emerge incomplete from the assembly station 16, the machine can be equipped with conventional means (not illustrated) such as will detect a substandard group 2 of cigarettes 3 and respond, for example, by stopping the pusher mechanism 17.

In this situation, that is to say with the pusher mechanism 17 idle and no groups 2 of cigarettes 3 being transferred to the pocket conveyor 20, the aforementioned control unit 28 will pilot the valve element 38, by way of the aforementioned actuator means (not illustrated), to shift from the active first position (not illustrated), extended and disallowing aspiration, to the inactive second position shown in FIG. 4, retracted and allowing aspiration.

Still referring to FIG. 4, the retraction of the valve element 38 causes the holes 32 to connect with the chamber 37, and the hopper 4 is able to communicate with the vacuum duct 33 connected to the negative pressure source 34. In this situation, the cigarettes 3 positioned nearest to the suction field 35 are attracted to the holes 32 and become attached stably, by way of their respective butt ends, to the rear wall 6 of the hopper 4 in which the holes 32 are located.

As a result of the aspirating force generated through the suction field 35, accordingly, a given number of cigarettes, denoted 40 in FIG. 4, will remain substantially locked against the rear wall 6 of the hopper 4 and impede any downward shift of the mass of cigarettes, denoted 41, occupying the part of the flow chamber 5 immediately above the feed section 7 affected by the blockage.

In like manner to the situation described above, the control unit 28 will pilot the opening movement of the valve element 38 on receiving a signal from the sensor 27 to indicate that the door 24 is open. In practice, on becoming aware of a malfunction in any of the feed sections 7, the operator opens the door 24 and the sensor 27 will immediately relay a signal to the computerized control unit 28, which in turn activates the valve element 38 so that the cigarettes 3 can be immobilized at the inlet of the feed section 7.

FIG. 2 shows the operational connection between the control unit 28 and the pusher mechanism 17, also the connections linking the control unit 28 to the valve element 38 and the sensor 27, represented in this instance as blocks.

FIG. 3 shows the operational connection between the control unit 28 and the sensor 27 indicating the open/closed status of the door 24, also the connections linking the control unit 28 to the pusher mechanism 17 and the valve element 38, again represented by blocks.

FIG. 4 shows the operational connection between the control unit 28 and the valve element 38, also the connections linking the control unit 28 to the pusher mechanism 17 and the sensor 27, represented by blocks.

In short, the movement of the valve element 38 between the first and second positions is piloted, through the agency of the aforementioned actuator means, by a change in the operating status of the pusher mechanism 17 and/or of the door 24.

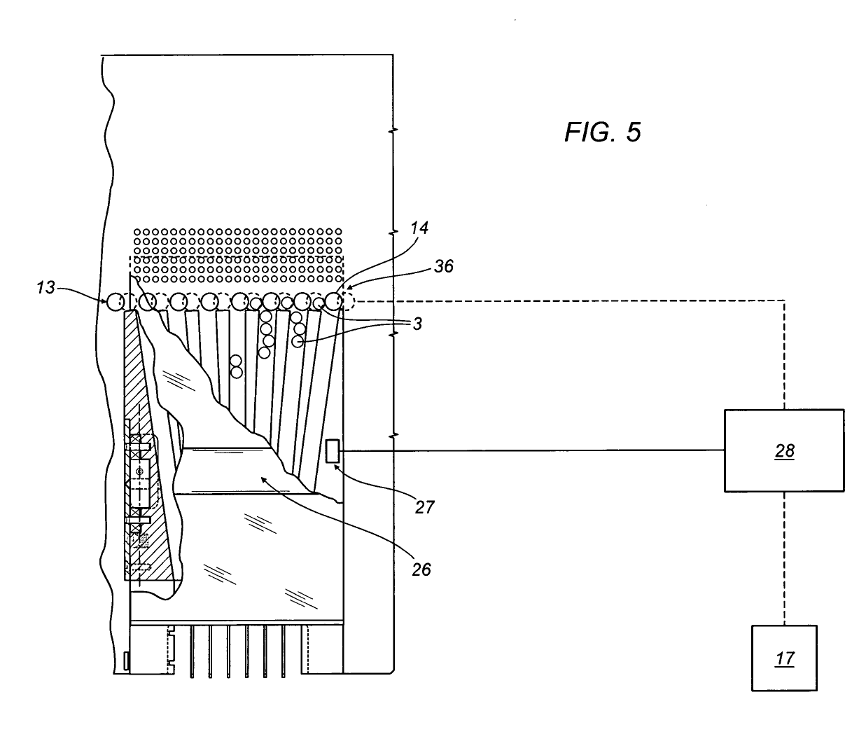

FIG. 5 illustrates an alternative embodiment of the present invention in which means 36 by which to block the movement of the cigarettes are mechanical in embodiment.

More particularly, such means comprise agitator elements 14 rendered capable of movement between a normal operating configuration, in which motion is transmitted to the cigarettes 3 occupying the flow chamber 5 so as to ease their passage toward the feed channels 10, and a configuration in which the feed channels 10 are occluded and the cigarettes 3 unable to advance.

In other words, the agitator elements 14 can be displaced, by means of actuator devices neither illustrated nor described further in the present specification, in such a manner as to create the aforementioned occluding configuration in which cigarettes 3 occupying the flow chamber 5 of the hopper 4 will be prevented from entering a given feed channel 10, at least in some measure, by the respective agitator element 14.

In the example of FIG. 5, the movable agitator elements 14 are illustrated in solid lines when positioned to create the occluding configuration, and in phantom lines when positioned for operation in the normal agitating configuration.

Thus, in the device according to the invention, means 36 by which to block the movement of the cigarettes 3, whether pneumatic or mechanical, are interlocked to the pusher mechanism and/or to the means 23 affording access to the feed section 7, which in the embodiments described and illustrated are provided by the door 24.

To advantage, moreover, the blocking means 36, whether pneumatic or mechanical, can be operated selectively and independently for each of the feed sections 7 of the hopper 4. Halting the advance of the cigarettes 3 within a given section 7 does not therefore impact negatively on the operation of the feed device 1 as a whole, since each section 7 is completely independent of the other sections 7, and these in effect can continue to feed cigarettes 3 to the respective stations 16 where they are formed into ordered groups 1. Consequently, there is no break in the continuity with which ordered groups 2 of cigarettes 3 are fed to subsequent processing stations (not illustrated) of the cigarette packer.

1. A device for feeding ordered groups of cigarettes in a packaging machine, comprising:
a hopper incorporating a plurality of feed sections from which cigarettes are directed into respective assembly stations to be formed into ordered groups, each feed section in turn comprising an inlet and an outlet through which the cigarettes are directed, and located between the inlet and the outlet, a plurality of feed channels delimited by pairs of dividing baffles;
pusher mechanisms associated one with each assembly station and serving to transfer each of the ordered groups to respective conveying means by which the selfsame groups are directed toward further processing stations, each pusher mechanism singly deselectable in the event of defects being detected in the formation of the groups of cigarettes;
means affording access to the feed sections;
blocking means, interlocked to the pusher mechanism or to the access means, or both, of which the function is to disallow the movement of the cigarettes along the channels toward the assembly station.

2. A device as in claim 1, wherein the blocking means can be operated selectively and independently for each of the single feed sections of the hopper.

3. A device as in claim 2, wherein the blocking means are activated in response to deactivation of the pusher mechanism.

4. A device as in claim 3, wherein each feed section of the hopper comprises a wall, removable at least in part and providing the means by which access is afforded to the selfsame section, and the blocking means are activated in response to the removal, at least in part, of the wall.

5. A device as in claim 4, wherein the at least partially removable wall comprises a door capable of movement at least between a closed configuration, and an open configuration in which access is afforded to the feed section.

6. A device as in claim 5, wherein the blocking means are pneumatic in operation.

7. A device as in claim 6, wherein blocking means comprise a suction field located near to the inlet of each feed section of the hopper and proportioned to attract a plurality of cigarettes, in such a manner that a given quantity of cigarettes can be retained in contact with a fixed portion of the selfsame hopper.

8. A device as in claim 7, wherein the suction field is incorporated into a wall of the hopper and comprises a plurality of holes by way of which a fluid connection is established between the hopper and a vacuum duct.

9. A device as in claim 7, comprising means by which to shut off the suction field and thereby prevent any fluid connection between the hopper and the vacuum duct.

10. A device as in claim 9, wherein shut-off means comprise a valve element piloted in operation by a change in operating status of the pusher mechanism or of the access means, or both, and capable of movement between an extended first position disallowing aspiration and a retracted second position allowing aspiration.

11. A device as in claim 1, wherein the blocking means are mechanical in operation.

12. A device as in claim 11, further comprising elements by means of which to agitate the cigarettes, located in close proximity to each of the feed channels and capable of movement at least between a first operating configuration, in which the cigarettes are agitated by the elements to ease their passage into the feed channels, and a second operating configuration in which the channels are occluded at least in part by the agitator elements and the selfsame elements thus perform the function of blocking means.

13. A device as in claim 12, wherein the movement of the agitator elements between the first and the second operating configurations is piloted by a change in operating status of the pusher mechanism or of the access means, or both.

14. A device for feeding ordered groups of cigarettes in a packaging machine, comprising:
a hopper incorporating a plurality of feed sections from which cigarettes are directed into respective assembly stations to be formed into ordered groups, each feed section in turn comprising an inlet and an outlet through which the cigarettes are directed, and located between the inlet and the outlet, a plurality of feed channels delimited by pairs of dividing baffles;
means located upstream of the channels, relative to a feed direction followed by the cigarettes along the selfsame channels, by which to block the movement of the cigarettes along the channel toward the assembly station.

15. A device as in claim 14, wherein blocking means comprise a suction field located near to the inlet of each feed section of the hopper and proportioned to attract a plurality of cigarettes, in such a manner that a given quantity of cigarettes can be retained in contact with a fixed portion of the selfsame hopper.

16. A device as in claim 1, wherein the blocking means are activated in response to deactivation of the pusher mechanism.

17. A device as in claim 1, wherein each feed section of the hopper comprises a wall, removable at least in part and providing the means by which access is afforded to the selfsame section, and the blocking means are activated in response to the removal, at least in part, of the wall.

18. A device as in claim 1, wherein the blocking means are pneumatic in operation.

19. A device as in claim 8, comprising means by which to shut off the suction field and thereby prevent any fluid connection between the hopper and the vacuum duct.

20. A device as in claim 3, wherein the blocking means are mechanical in operation.
